(19) United States
(12) Patent Application Publication
(10) Pub. No.: US 2015/0021315 A1
(43) Pub. Date: Jan. 22, 2015

(54) COMBINED DECOUPLING AND HEATING SYSTEM

(71) Applicant: Blanke GmbH & Co. KG, Iserlohn-Stenglingsen (DE)

(72) Inventor: Peter Blanke, Iserlohn (DE)

(21) Appl. No.: 14/333,592

(22) Filed: Jul. 17, 2014

(30) Foreign Application Priority Data
Jul. 17, 2013 (DE) 20 2013 006 416.1

(51) Int. Cl. H05B 3/03

(52) U.S. Cl. CPC H05B 3/03
USPC 219/553; 252/500; 252/502; 252/506

(57) ABSTRACT

The invention relates to a combined decoupling and heating system, in particular for installing ceramic tiling using the thin bed method, having at least one anchoring layer formed from a structure element for a filler compound that is to be introduced in the area of the upper side of the decoupling and heating system and that is ductile during processing and hardens thereafter. The anchoring layer is formed at least in part of mechanically highly stressable reinforcement fibers made of a material that itself is electrically conducting or that has become electrically conductive through coatings and/or additives, whereby the reinforcement fibers can be heated up by conducting electrical current thus forming the heating layer of an electrically operable area heating system.

### RELATED APPLICATIONS

This application claims priority to German Patent Application No. DE 20 2013 006 416, Filed Jul. 17, 2013. This application is herein incorporated by reference in its entirety for all purposes.

### FIELD OF THE INVENTION

The invention relates to a combined decoupling and heating system, in particular for ceramic tiling according to the thin bed method

### BACKGROUND OF THE INVENTION

Today, ceramic tiling and in particular tiles are usually installed according to the so-called thin bed method, where the ceramic tiling is laid in a thin tile mortar adhesion layer. During installation of ceramic tiling using this method, problems arise whenever the substrate under the ceramic tiling is not sufficiently stable to prevent relative movement of the substrate. This may be the case when tiling is to be laid on swaying wood floors or other insufficiently stable substrates. The relative movability of the substrate frequently leads to a gradual destruction of the tiles, whereby the durability period of such coverings is reduced and possibly leading to high renovation costs.

It has, therefore, been recommended multiple times to lay such ceramic tiling more durably by effecting targeted decoupling between the ceramic tiling and the substrate. Such a decoupling system ensures mechanical decoupling between the tiling and the substrate such that relative movements between the tiling and the substrate are possible and do not lead to the mentioned gradual destruction of the tiling. However, such decoupling systems often have the disadvantage that the mechanical load capacity of the tiling and of the decoupling system is unsatisfactory. On the one hand, anchoring of the tiles at the decoupling system was not sufficiently strong and on the other hand the compression strength of the decoupling system itself was not optimal. DE 10 2004 026 652 A1 recommended an improved and very thin decoupling system, where an anchoring layer having cavities is essentially fully filled with the tile adhesive after introducing a filler compound in the form of a tile adhesive and where a reinforcement layer that is embedded in the hardened filler compound together with the anchoring layer fulfills a stiffening and reinforcement function for dissipating mechanical loads that are introduced from above.

In addition to the requirement of secure decoupling of ceramic tiling and the substrate, for example in old buildings that are to be restored but also in new buildings, ceramic tiling is also frequently used on top of floor heating systems. Floor heating systems are typically heating systems placed in the floor structure underneath floor coverings, where either a thermal carrier fluid circulates in a piping system installed in a meander pattern, or where electric heating elements cause a heating effect underneath the floor covering and thus heat the floor covering from below. Due to the large heating surface, such a floor heating system can preferably operate in a low-temperature range. However, such heating systems do also significantly stress, for example, ceramic flooring mechanically, because the different thermal expansion of the different layers of the floor heating system can cause relative movements between the ceramic flooring and its substrate, which again can lead to stress cracking and thus to a gradual destruction of the ceramic tiling.

Thus, it has been recommended in this case as well to place a decoupling mat between the classical layered structure of the floor heating and the ceramic tiling, thus decoupling the substrate and the floor heating from the ceramic tiling. However, this leads to a significant increase of the overall thickness of the floor structure, which is often not acceptable, for example when renovating old buildings. Heating wires installed on top of a decoupling mat in receptacles can be used as electrical heating elements as presented in DE 10 2006 004 755 B4, however, the manual installation entails high manufacturing expenditures and also causes a respective additional layer thickness. Another solution according to DE 10 2005 015 051 A1 provides for heating layers made of electrically conducting nonwoven or woven fabrics or scrims in place of heating wires for the floor heating structure, wherein such heating layers can be heated using electrical current and these heating layers transfer the heat to the ceramic tiling from below. For this purpose, the heating layers may consist of electrically conducting fibers such as carbon fibers, for example designed as nonwovens, which can convert the flowing electrical current into heat. These heating layers are then embedded in a layered structure such that the electrically conducting heating layer is defined by insulating layers at the top and bottom side. Furthermore, aside from a heating layer, additional mechanically stressable carrier layers are necessary to ensure the mechanical stability of the heating layer. This again increases the overall thickness of the layer structure. Furthermore, installing such separate heating layers requires additional labor expenditures and must be carried out very carefully.

What is need is, therefore, to develop a decoupling system of the generic kind such that the decoupling system itself constitutes a component of a heating system.

### SUMMARY OF THE INVENTION

The solution of the problem according to various embodiments of the invention stem from the characteristic features of claim 1 together with the features of the preamble. Additional advantageous embodiments of the invention become apparent from the dependent claims.

One embodiment of the invention describes a combined decoupling and heating system, in particular for laying ceramic tiling using the thin bed method, having an anchoring layer formed from a structure element for a filler compound that is to be introduced in the area of the upper side of the decoupling and heating system that is ductile during processing and hardens thereafter. Such a decoupling system of the generic kind is developed further in that the anchoring layer is formed at least in part of mechanically highly stressable reinforcement fibers made of a material that itself is electrically conducting or that has become electrically conductive through coatings and/or additives, whereby the reinforcement fibers can be heated up by conducting an electrical current thus forming the heating layer of an electrically operated area heating system. With the formation of the anchoring layer made of reinforcement fibers which are both highly mechanically stressable and heatable by conducting electrical current, the two functions of mechanical decoupling and heating can be realized in one single mechanically stable layer, which on the one hand can reduce the number of components and layers and on the other hand can significantly reduce the overall thickness of the substructure for the ceramic tiling, for example. Here, the reinforcement fibers are intended for both receiving the forces originating from the load on the ceramic tiling, for example, in the anchoring layer and transferring them decoupled to the substrate, and as a significant component of the heating layer, which is heated by conducting electrical current and can transfer this heat to, for example, the ceramic tiling and thus into the room. The fact that the fibers used for reinforcement cover essentially the entire area of the structural element and thus are essentially distributed essentially uniformly at this area is utilized in this case. Thus heating of this area is also essentially uniform without the need for integrating additional heating elements or for providing several combined layers for heating and mechanical stabilization of the heating layer as is the case with other heating systems. Furthermore, the decoupling and heating system can be installed, for example, by the floor tiler or flooring installer using methods known to him such as gluing the anchoring layer using tile adhesive or the like, and thus does not require additional crafts or persons skilled in the art for the installation. In particular, however, the overall thickness of the required layer structure for decoupling and heating is reduced significantly because, for example, separate insulating and stabilizing layers for the heating elements can be omitted since this task is assumed simultaneously by the reinforcement fibers. In addition, the different expansions between the heating elements and the other layer structure and the, for example, ceramic tiling, are reduced significantly in that the reinforcement fibers that form the heating elements enter into a close bond with the filler compound and thus can be securely connected to the ceramic tiling, for example, or other coverings as well.

It can be advantageous if the electrically conducting reinforcement fibers are designed as woven fabrics and/or as scrims and/or as nonwoven fabrics and are arranged in layers. In this manner, the mechanical and electrically heating properties of the reinforcement fibers can be adapted to a large extent and can be influenced according to the respective requirements, for example by the arrangement and the layer thickness of the reinforcement fibers in the anchoring layer. Furthermore, it is also possible to influence the mechanical and electrical properties and thus the heating properties through the length of the reinforcement fibers depending on the demand and on the required heating power.

In a first embodiment, the conducting reinforcement fibers can be formed of fibers on carbon basis, in particular carbon fibers, and/or glass fibers and/or electrically conducting synthetic fibers and/or metallic fibers or similar highly stressable fibrous materials. It is also conceivable to use combinations of such fibers in the anchoring layer. Carbon fibers and metallic fibers are electrically conducting and with appropriate dimensioning, for example through appropriate cross-sections or by bundling thin individual fibers into strands, can assume and transfer respective mechanical loads. Electrically non-conducting fibers such as glass fibers or the like can be made to conduct electricity through additives or coatings, which then allows for using these fibers for heating purposes as well when they conduct electricity. It is also conceivable to integrate additional electrically conducting components such as powders, emulsions or the like, which are then also electrically heatable, into the anchoring layer in order to enhance the heating effect. It is also conceivable to work electrically conducting and non-conducting reinforcement fibers into the anchoring layer, thus combining their properties in the anchoring layer.

It is of particular significance for the conductance of electrical current to arrange at least the electrically conducting reinforcement fibers within the anchoring layer such that at least some of these reinforcement fibers intersect and are in electrical contact with each other. This affects conductance of the electrical current between the individual reinforcement fibers at the intersecting and contact points and other reinforcement fibers, which ensures, that, for example, individual mechanically interrupted reinforcement fibers, which therefore do not conduct the electrical current are bridged and the heating power of the anchoring layer is not influenced significantly by such defects. The multiplicity of contact points between the reinforcement fibers thus ensures the uniform heating effect even in case of localized defects or errors in workmanship by the current searching at each point for its own path through the network of reinforcement fibers and thus heats up the reinforcement fibers. It is advantageous in this regard if the reinforcement fibers are arranged lattice-like in the anchoring layer and intersect multiple times with other reinforcement fibers that are oriented differently in the anchoring layer. Such a lattice-like anchoring layer can be manufactured easily and thus cost-effectively using conventional machinery.

In one conceivable embodiment, the structure element can be prefabricated like a mat or a strip such that the installer of the decoupling and heating system can design and specify the structure element like a mat of conventional decoupling systems or fill it with the filler compound. This procedure is familiar to the installer of, for example, ceramic tiling such as a floor tiler and can be performed properly by him.

It is furthermore advantageous if the filler compound is electrically insulating. In this manner, the electrically conducting reinforcement fibers can be securely insulated electrically from the other layers of the floor structure, if necessary.

It is additionally advantageous if contacting zones are provided in the edge area of the anchoring layer, where the anchoring layer can be connected electrically to an external power supply and/or to other adjacent anchoring layers. Such contacting zones can be formed, for example, in the edge area of the anchoring layer from protruding reinforcement fibers or from protruding electrically conducting layers of a conducting material such as a copper foil or the like, with which the reinforcement fibers of the structure element are connected by electrical contact. This allows on the one hand for secure contacting of the externally provided power supply into an installed decoupling and heating system; furthermore contacting of individual strips of the anchoring layer can be ensured at the contact points of a, for example, strip-like placed decoupling and heating system.

With regard to electrical safety of the decoupling and heating system, it is advantageous if the reinforcement fibers are operated using low voltage to heat the heating layer. Such low voltages in a range of 12 V, 24 V or even 48 V are as a rule harmless for people even in case of malfunctions and can, therefore, also be used as floor heating, for example, in the wet area of a bathroom.

It is furthermore advantageous if a reinforcement layer is arranged at least in sections at the upper side of the anchoring layer. In this manner, the anchoring layer arranged at the upper side, and in particular the reinforcement layer placed above and attached to it, ensure that tile grout introduced from above connects fully with the decoupling and heating system, thus ensuring a respective load-carrying capacity of the decoupling and heating system.

One embodiment can provide that the lattice-like structure element is formed of individual rods arranged lattice-like in relation to each other and affixed to each other at the intersection points of the lattice. Such a lattice-like structure element can be manufactured easily from similar prefabricated individual rods making it thus possible to work with inexpensively made individual rods that are wound on drums and are positioned toward each other for manufacturing the lattice-like structure element. This makes the manufacture of such lattice-like structure elements very cost-effective and simple. Different from known decoupling systems, it is not necessary to produce expensive tools that produce areas that are at an angle to each other or are formed in other ways. In an additional embodiment, it can be ensured that the individual rods of the lattice-like structure element have an essentially rectangular cross-sectional shape. Especially if the edges of the individual rods have non-uniform dimensions, the thickness of the lattice-like structure elements can be modified easily and adapted to different requirements.

It is of particular advantage if, in one embodiment of the present invention, the intersecting individual rods of the lattice-like structure element are arranged such that a first layer consists of individual rods each with a same orientation underneath a second layer of individual rods at an angle thereto and each with the same orientation in relation to each other. Thus, when manufacturing the lattice-like structure element, there is no need to cross the individual rods as is the case with a textile fabric, which additionally simplifies the manufacture and also ensures that the similar layers of the lower and the upper layer of individual rods form respective cavities between them that can be used for introducing the filler compound. It is conceivable that the lattice-like structure of the individual rods have the shape of a diamond, rectangle or square. Of course other geometric patterns are also conceivable.

The manufacture of the structure element can be further simplified if the individual rods of the two layers are welded or pressed together under mechanical pressure in the intersecting areas. For example, heating up the individual rods that can, for example, be formed plastically under the influence of temperature, can ensure that softening and welding to the individual rod underneath occurs in the contact area of the individual rods, thus creating a mat-like composite of the individual rods. The connection of the individual rods ensures at the same time that the electrical contact resistance between the individual rods is low and that the individual rods are then essentially connected to form a heating mat.

It is furthermore conceivable that, for example, when welding the individual rods together, the individual rods of the structure element have edge areas at least at the intersecting points that are tilted toward each other, thus forming undercut sections at the individual rods. Through plastic forming of the individual rods in the area of the intersecting points, for example through temperature influence, the individual rods are slightly formed by the mechanical pressure, thus changing their orientation depending on the position of the individual rod that is to be connected to the other individual rod. This leads to the formation of undercuts, which are of particular advantage for anchoring in the filler compound. Due to its plasticity, the filler compound enters into the undercut areas during installation, and can attach much better to the anchoring layer after hardening due to the undercut.

In another embodiment, it is conceivable that the reinforcement layer is welded or glued to the anchoring layer. The reinforcement layer can thereby be embedded well in the filler compound and it also hangs solidly on the anchoring layer, which is also filled with the filler compound. This creates a particularly good connection between the filler compound and the reinforcement layer or the anchoring layer, respectively. It is conceivable that the reinforcement layer is formed as a lattice-like woven, preferably as a glass-fiber woven, which serves for secure anchoring with the filler compound that is to be introduced above the decoupling and heating system.

Regarding the dimensions of the individual layers of the decoupling and heating system it is conceivable that the thickness of the anchoring layer is between 2 and 6 millimeters and that in one embodiment the overall thickness of the decoupling and heating system is essentially between 2 and 8 millimeters. In this manner, the decoupling and heating system does not significantly add to the thickness of a specified substrate and can be used without problems even with spatially tight installation conditions.

It is of significant advantage for the usage properties of the decoupling and heating system according to one embodiment of the invention if the anchoring layer after introducing the filler compound is essentially filled fully with the filler compound and the reinforcement layer embedded in the fill compound fulfills a stiffening and reinforcement function for dissipating mechanical loads introduced from above. This allows for load dissipation via significantly greater layer thicknesses than with known decoupling and heating systems because the entire layer thickness of the anchoring layer additionally bears the mechanical load and at the same time is reinforced by the reinforcement layer.

The decoupling and heating system according to one embodiment of the invention can have at least one additional layer for insulation purposes, in particular for thermal insulation and/or for impact sound insulation, which can be arranged, for example, at the bottom side of a decoupling and heating system arranged on the floor. This can achieve additional properties of the decoupling and heating system by the additional insulation layer, making further insulation work prior to installing the decoupling and heating system unnecessary.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a cross sectional elevation view of a decoupling and heating system according to one embodiment of the invention for explaining the layer structure,

FIG. 2 is a top plan view of a decoupling and heating system according to one embodiment of the invention according to FIG. 1.

### DETAILED DESCRIPTION

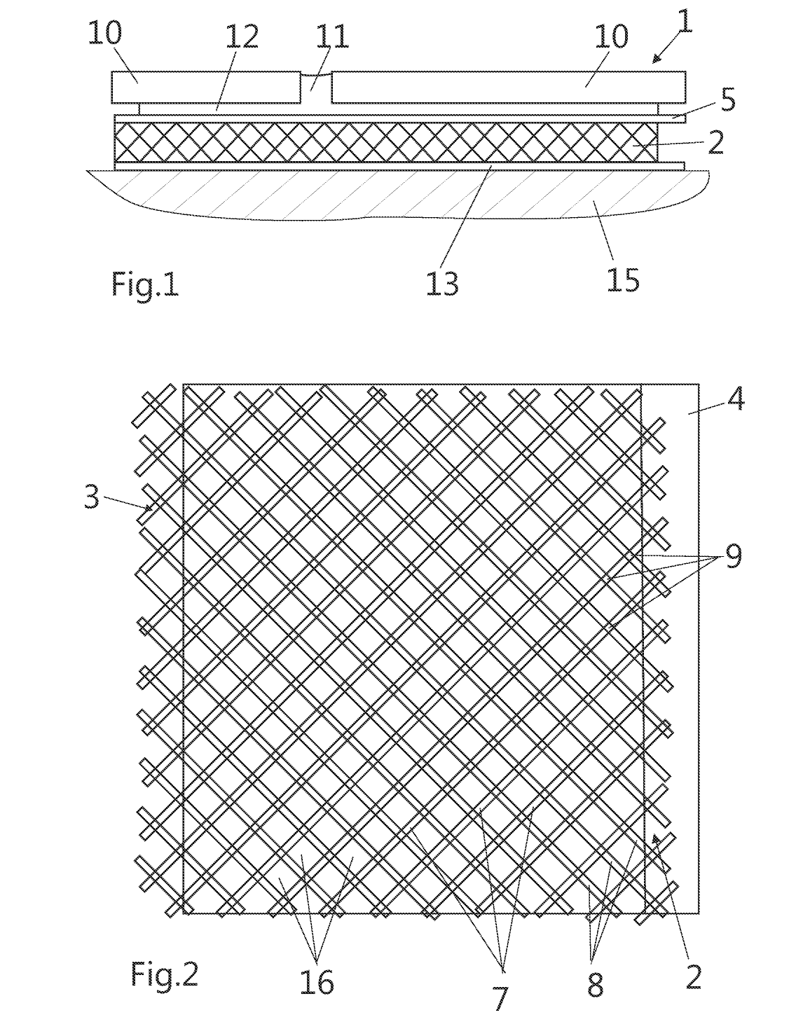

FIG. 1 shows a sectional side view of the layer structure of a combined decoupling and heating system 1 according to one embodiment of the invention, while FIG. 2 shows a top view. The decoupling and heating system 1 is shown in the installed condition on a substrate 15, for example cement screed or the like, where tiling consisting of tiles 10 that has been laid in tile mortar 12 by applying the thin bed method can be recognized above the decoupling and heating system 1 and where the joints 11 between the individual tiles 10 are also filled with tile mortar 12.

The decoupling and heating system 1 according to one embodiment of the invention has on its bottom side a nonwoven layer 13 for placement on the substrate 15. An anchoring layer 2 consisting of a lattice-like structure, which will be explained later, is connected to the nonwoven layer 13 above the nonwoven layer 13. The connection can be made, for example, by gluing or welding in a basically known manner dependent on the materials used.

The anchoring layer 2 as well as the reinforcement layer 5 connected to it and arranged above it are used for anchoring the decoupling and heating system 1 at the tile mortar 12 and thus at the layer consisting of the tiles 10. The reinforcement layer 5 may, for example, consist of a glass-fiber woven that is arranged lattice-like in an essentially known manner and that has respective openings and free areas such that the tile mortar 12 can enter as deep as possible into the anchoring layer 2. The anchoring layer 2 has receiving spaces 16 for the tile mortar 12, which will be explained in greater detail, and is used to improve anchoring of the tile mortar 12 to the decoupling and heating system 1.

Configuring the tile layer made up of the tiles 10 is done in that the tile mortar 12 is applied on the top side of the reinforcement layer 12 prior to setting the tile and using a trowel is pressed as deeply as possible through the openings in the reinforcement layer 5 into the anchoring layer 2. The tile mortar 12, which is processed in its plastic state, to a large extent fills the receiving spaces 16 in the anchoring layer 2 and surrounds the individual rods 7, 8 of the anchoring layer 2 almost entirely, with the manner of the formation of said rods still to be described. After hardening of the tile mortar 12, a very strong bond has formed between the anchoring layer 2, the reinforcement layer 5 and the tile mortar 12, which for one anchors the tiles 10 strongly at the decoupling and heating system 1 and for another causes a stable, sheet-like embodiment of the anchoring layer 2. Because of this, the decoupling and heating system 1 has a good load-bearing capacity for mechanical loads being introduced on the top side of the tiles 10.

The lattice-like anchoring layer 2 of one embodiment is formed of individual rods 7, 8 arranged at an angle to each other, and arranged on top of each other form a two-layer arrangement. The individual rods 7, 8 each have an approximately rectangular cross-section and are welded together at the intersecting points 9, for example by thermal methods. This forms in a most simple manner an arrangement on top of each other of approximately parallel groups of individual rods 7, which are connected to also parallel groups of individual rods 8, which are placed at an angle to the group of individual rods 7. Receiving spaces 16 are formed between the individual rods 7 or 8, respectively, in the anchoring layer 2.

The lattice-like structure of the individual rods 7, 8 also has the advantage that during welding of the individual rods 7, 8 in the area of the intersecting points 9 areas that have undercuts form at the individual rods 7, 8, thus leading to a strong bond between the tile mortar 12 that enters into these areas and the individual rods 7, 8 after hardening.

When large areas are to be installed, it is recommended to let both the reinforcement layer 5 and the anchoring layer 2 protrude in overlapping areas so far beyond the edges that they can be glued to adjacent layers in an overlapping manner or can be attached to them in some other way.

It is understood that the arrangement of the individual rods shown in FIG. 2 is only one example and that any kind of geometric pattern that is advantageous for the properties of the decoupling and heating system 1 mentioned here can be formed from such individual rods 7, 8.

The heating function of the combined decoupling and heating system 1 with the anchoring layer 2 consisting at least in part of mechanically highly stressable reinforcement fibers 7, 8 is now achieved in that the material of the reinforcement fibers 7, 8 itself is electrically conducting or has become electrically conductive through coatings and/or additives, whereby the reinforcement fibers 7, 8 can be heated up by conducting electrical current, thus forming the heating layer of an electrically operable area heating system. Here, the reinforcement fibers 7, 8 are intended for both receiving the forces originating from the load of the ceramic tiling 10 in the anchoring layer 2 and transferring them decoupled to the substrate as well as being a significant component of the heating layer, which is heated up by the flow of electrical current and that can transfer this heat to, for example, the ceramic tiling 10 and thus into the room. The fact that the reinforcement fibers 7, 8, used for reinforcement, essentially cover the entire area of the structural element as shown in FIG. 2 and are thus essentially distributed essentially uniformly at this area is utilized in this case. The density of the reinforcement fiber 7, 8 arrangement can be very different, with a relatively big distance as shown schematically in FIG. 2 or also with a very small side distance between the adjacent reinforcement fibers 7, 8. The electrically conducting reinforcement fibers 7, 8 can be configured as a woven fabric and/or scrims or as a nonwoven fabric and can be arranged in layers. Heating of this area is thus also essentially uniform without the need for integrating additional heating elements or for providing several combined layers for heating and mechanical stabilization of the heating layer as is the case with other heating systems. Furthermore, the decoupling and heating system 1 can be installed, for example, by the floor tiler or flooring installer using methods known to him such as gluing the anchoring layer 2 using tile adhesive 12 or the like. In addition, the different expansions between the reinforcement fibers 7, 8 serving as heating elements and the other layer structure and the, for example, ceramic tiling 10 are reduced significantly in that the reinforcement fibers 7, 8 that form the heating elements enter into a tight bond with the filler compound 12 and can thus be securely connected to the ceramic tiling 10, for example, or to other coverings.

Fibers on carbon basis, in particular carbon fibers, and/or glass fibers and/or electrically conducting synthetic fibers and/or metallic fibers or similar mechanically highly stressable fibrous materials can serve as electrically conducting reinforcement fibers 7, 8. Carbon fibers and metallic fibers are themselves electrically conducting and with appropriate dimensioning, for example through appropriate cross-sections or also bundling thin individual fibers into strands (so-called rovings) can assume and transfer respective mechanical loads. Electrically non-conducting reinforcement fibers 7, 8 such as glass fibers or the like can be made to conduct electricity through additives or coatings, which then also allows for using these reinforcement fibers 7, 8 for heating purposes when they conduct electricity. It is also conceivable to work electrically conducting and non-conducting reinforcement fibers 7, 8 into the anchoring layer 2, thus combining their properties in the anchoring layer 2.

The electrically conducting reinforcement fibers 7, 8 are arranged within the anchoring layer 2 such that the reinforcement fibers 7, 8 intersect and are, for example, pressed together having an electrical contact. This affects conductance of the electrical current between the individual reinforcement fibers 7, 8 at the intersecting and contact points 9 and other reinforcement fibers 7, 8, which ensures, that, for example, individual mechanically interrupted reinforcement fibers 7, 8, which therefore do not conduct the electrical current, are bridged and the heating power of the anchoring layer 2 is not influenced significantly by such defects.

Additional decoupling and heating systems 1, for example formed as strips, can thus be easily contacted mechanically and electrically in the edge area of the decoupling and heating system 1 such that the reinforcement fibers 7, 8 protrude at the side in an edge zone 3 and thus overlap the next strip of the adjacent decoupling and heating system 1. This can establish both a mechanical and an electrically conducting contact to adjacent strips of the decoupling and heating system 1.

To supply the externally provided electrical current, a contact area 4 can be designed on the outside, which may consist, for example, of an electrically well conducting copper layer and can be applied to the reinforcement fibers 7, 8 on the edge side providing electrical contact. Electrical current can be fed to these contact areas 4 via respective—not shown—contact shoes or the like.

Reference Number List

1—Decoupling and Heating System

2—Anchoring layer

3—Protrusion, anchoring layer

4—Contact area

5—Reinforcement layer

7—Individual rod

8—Individual rod

9—Intersecting area

10—Tile

11—Joint

12—Tile mortar

13—Nonwoven fabric

15—Substrate

16—Receiving spaces

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A combined decoupling and heating system, in particular for installing ceramic tiling using the thin bed method, comprising:
at least one anchoring layer formed from a structure element for a filler compound that is to be introduced in the area of the upper side of the decoupling and heating system and that is ductile during processing and hardens thereafter, wherein the anchoring layer is formed at least in part of mechanically highly stressable reinforcement fibers made of a material that itself is electrically conducting or that has become electrically conductive through coatings and/or additives, whereby the reinforcement fibers can be heated up by conducting electrical current thus forming the heating layer of an electrically operable area heating system.

2. The decoupling and heating system as in claim 1, wherein the electrically conducting reinforcement fibers are designed as a woven fabric and/or scrim and/or a nonwoven fabric and are arranged in layers.

3. The decoupling and heating system as in claim 1, wherein the electrically conducting reinforcement fibers are formed of fibers on carbon basis, in particular carbon fibers, and/or glass fibers and/or electrically conducting synthetic fibers and/or metallic fibers or similar mechanically highly stressable fibrous materials.

4. The decoupling and heating system as in claim 1, wherein electrically conducting and electrically non-conducting reinforcement fibers are worked into the anchoring layer.

5. The decoupling and heating system as claim 1, wherein at least the electrically conducting reinforcement fibers are arranged within the anchoring layer such that at least some of these reinforcement fibers intersect and have electrical contact with each other.

6. The decoupling and heating system as in claim 5, wherein the reinforcement fibers are arranged lattice-like in the anchoring layer and intersect multiple times with other reinforcement fibers that are oriented differently in the anchoring layer.

7. The decoupling and heating system as in claim 1, wherein in addition to the reinforcement fibers other electrically conducting elements are arranged in the anchoring layer and are connected electrically conducting with the reinforcement fibers.

8. The decoupling and heating system as in claim 1, wherein the structure element is prefabricated mat-like or strip-like.

9. The decoupling and heating system as in claim 1, wherein the filler compound is designed to be electrically isolating.

10. The decoupling and heating system as in claim 1, wherein contact zones are provided in the edge area of the anchoring layer in which the anchoring layer can be electrically connected to an external power supply and/or to other anchoring layers that are to be arranged adjacent.

11. The decoupling and heating system as in claim 10, wherein the contact zone is formed from protruding reinforcement fibers in the edge area of the anchoring layer.

12. The decoupling and heating system as in claim 10, wherein the contact zone in the edge area of the anchoring layer consists of protruding, electrically conducting layers, with which the reinforcement fibers of the structure element are connected having electrical contact.

13. The decoupling and heating system as in claim 1, wherein the reinforcement fibers can be operated with low voltage for heating the heating layer.

14. The decoupling and heating system as in claim 1, wherein a reinforcement layer is arranged at least in sections at the upper side of the anchoring layer.

15. The decoupling and heating system as in claim 1, wherein the lattice-like structure element is formed from rod-shaped individual rods that are arranged lattice-like in relation to each other and are configured at the intersecting points of the lattice.

16. The decoupling and heating system as in claim 15, wherein the individual rods of the lattice-like structure element have an essentially rectangular cross-sectional shape.

17. The decoupling and heating system as in claim 15, wherein the intersecting individual rods of the lattice-like structure element are arranged such that a first layer consists of individual rods each oriented in the same manner underneath a second layer of individual rods at an angle thereto and each oriented in the same manner toward each other.

18. The decoupling and heating system as in claim 15, wherein the lattice-like structure consisting of the individual rods has a diamond, rectangular or square shape.

19. The decoupling and heating system as in claim 15, wherein the individual rods of the anchoring layer are welded together in the intersecting region under mechanical pressure.

20. The decoupling and heating system as in claim 15, wherein the individual rods of the lattice-like structure element have—at least at the intersecting points—edge areas that are tipped toward each other thus creating undercut sections at the individual rods.

21. The decoupling and heating system as in claim 1, wherein the reinforcement layer is glued or welded to the anchoring layer.

22. The decoupling and heating system as in claim 1, wherein the thickness of the anchoring layer is between 2 and 6 millimeters.

23. The decoupling and heating system as in claim 1, wherein after introducing the filler compound the anchoring layer is essentially fully filled with the filler compound and in that the reinforcement layer that is embedded in the hardened filler compound fulfills a stiffening and reinforcing function for dissipating mechanical loads introduced from above.

24. The decoupling and heating system claim 1, wherein the decoupling and heating system has at least one additional layer for insulation, in particular for thermal insulation and/or for impact sound insulation.
